(19) United States
(12) Patent Application Publication
(10) Pub. No.: US 2009/0015196 A1
(43) Pub. Date: Jan. 15, 2009

(54) Power Supply for Sensors and Other Electronic Devices

(75) Inventors: Nelson L. Baxter, Mooresville, IN (US); Kenneth R. Piety, Knoxville, TN (US)

Correspondence Address: NORMA E HENDERSON;HENDERSON PATENT LAW, 13 JEFFERSON DR, LONDONDERRY, NH, 03053, US

(73) Assignee: Azima, Inc., Woburn, MA (US)

(21) Appl. No.: 12/121,735

(22) Filed: May 15, 2008

Related U.S. Application Data
(60) Provisional application No. 60/938,180, filed on May 15, 2007.

(51) Int. Cl. H02J 7/02

(52) U.S. Cl. 320/108

(57) ABSTRACT

A power supply comprises at least one transformer that is placed around an active power line and is connected through at least one power conditioning system to provide a conditioned power source for at least one electronic device. Power is generated by scavenging power from the power being supplied on the power line. An asset-monitoring apparatus comprises a sensor package in communication with a monitoring system and a power supply that generates power for the sensor package, the power supply including a transformer placed close to the power line powering the asset being monitored and a power conditioning system that conditions the power supply for use by the sensor package. An optional energy storage device may receive power from the power conditioning system and provide primary or backup power for the sensor package or other electronic device.

### RELATED APPLICATIONS

This application claims the benefit of U.S. Provisional Application Ser. No. 60/938,180, filed May 15, 2007, the entire disclosure of which is herein incorporated by reference.

### FIELD OF THE TECHNOLOGY

The present invention relates to device power supplies and, in particular, to a system that scavenges power for supply to sensors and other devices.

### BACKGROUND

Sensors and associated electronics are typically used to monitor the state of hardware. Historically, these sensors have been hard wired, but the expense of hard wiring sensors has driven the development of wireless sensors. Most such sensors require line power, but it is frequently not feasible to have 110V-powered devices in many locations because of the expense of running power to the machine. This has prompted a search for alternative power sources for sensors. One option is to power the sensor from the same source that powers the asset being monitored. However, many of the assets being monitored operate on high voltages (e.g. 480V to 6900V) that are not suitable for directly powering sensors and other electronics.

Another option is a self-powered device. Battery-powered devices were the first iteration of making electronics truly wireless. The drawbacks of this approach include that battery performance varies with environment, that batteries discharge over time even when not in use, and that batteries must be replaced when spent. The latter can present a particular problem when the sensor is not easily accessed. Further, even when monitoring the condition of the battery is possible, it may be difficult or inconvenient to determine when a battery has been, or is about to be, discharged. There is also a well-known tradeoff between battery life and data frequency/volume when using battery-powered wireless devices with common wireless protocols such as 802.11, because such protocols are “power hungry.” Lower bandwidth networks use lower power, but also cannot transmit as much information. Several such options exist, but all have drawbacks. For example, low powered networks often use a proprietary network protocol and have low bandwidth, and so are unsuitable for transmitting vibration signatures. Existing networks that solve this problem can transmit vibration signatures a few times a day, but consequently have a battery life in the range of only one- to two-years.

Where sunlight is available, solar power may be used as an alternative to batteries. However, if sunlight is not available in sufficient quantity, such as during a prolonged period of bad weather, the sensor may fail. Further, some sensors may need to be installed in locations where no direct path to sunlight is available.

Another alternative to batteries is the use of power-scavenging devices. Scavenged energy can be used to power sensors and electronics directly or to charge a battery or capacitor. Devices have been developed that convert vibration and fluid flow to electronic energy. In devices employing vibration, the device is powered from the vibration coming off the associated machine. There are several companies pursuing this methodology, but there are some drawbacks, including that the methodology cannot be employed when the associated machine produces little to no vibration in one or more states and that this type of device typically produces a very low level of power, so it would not be suitable in a situation where data needs to be transmitted on a frequent basis.

In devices powered by fluid flow, power for the monitoring device is generated by scavenging power from the fluid flow within a pipe. For example, U.S. Pat. No. 7,112,892 (Mahowald Sep. 26, 2006) teaches a generator installed within a pipe having fluid flow. The generator includes a paddlewheel that is rotated by the fluid flow to generate current to power a sensor. This system is advantageous, but cannot be employed when there are no pipes having fluid flow available or when no fluid flow is occurring through the pipe being used. It also has the drawback of requiring that a hole be drilled in the pipe for installing the generator, permanently altering the pipe and presenting opportunities for leaks and other associated problems. This type of device is also not suitable for use with high temperature fluids or in corrosive or erosive fluid environments.

At least one device is known that scavenges power from magnetic flux arising from current flowing in an associated machine. U.S. Pat. App. Pub. No. US2006/0076838A1 (Solveson et al. Apr. 13, 2006) teaches monitoring-related devices, such as sensors, a radio transceiver circuit, and a processor, that are powered by magnetically coupling one or more coils around the power bus that is being monitored. The power supply for the monitoring devices employs voltage produced by the flux arising from the current flowing in the power bus. A drawback of this system is that the power supply for the monitoring devices is integral to the power bus; it must be installed when the power bus is assembled and cannot therefore be added and/or removed as needed. This device is therefore not useful for powering monitoring-related devices for other types of assets, including existing assets to which monitoring devices must be added later and assets that do not themselves actually produce enough flux to produce sufficient voltage to power the monitoring devices.

What has been needed, therefore, is a power source for sensors and other electronic devices that is consistently available, simple and inexpensive to implement and operate, preferably does not require periodic replacement and/or servicing, and can be installed, reconfigured, or removed at any time. What has been further needed is a self-powered electronic device that is simple and inexpensive to power from available power sources without the need to make any alterations to those power sources.

### SUMMARY

In one aspect, the present invention is a power supply that comprises a transformer that is placed around an active power line and is connected to a power conditioning system that provides a conditioned power source for an electronic device. Power for the electronic device and the associated conditioning hardware is generated by scavenging power from the power being supplied on the power line. In an alternative embodiment, the power supply includes an energy storage device that can provide an alternate source of power to the electronic device and can be recharged by the power conditioning system. In another aspect, the present invention is an electronic device powered by scavenging electronic energy via a transformer placed around a power line.

In a preferred embodiment, an asset-monitoring apparatus comprises a sensor package in communication with a monitoring system and a device that generates power for the sensor package. Power for the sensor, any associated conditioning hardware, and the wireless communications device is generated by scavenging power from the power being supplied to the machine that is being sensed. The power-generating device includes a current transformer placed close to the power line powering the asset being monitored and connected to a power conditioning system that provides a conditioned power supply for the sensor package. In an alternative embodiment, the system includes an energy storage device that can provide an alternate source of power for the sensor package and can be recharged by the power conditioning system.

In other alternative embodiments, the power supplied to the electronic device can be increased by using multiple transformers, with or without multiple power conditioning units, in order to scavenge sufficient power. The power supply of the present invention may also be used for powering multiple devices, either in parallel, if sufficient current is available, or alternately, if one or more of the powered devices are intended to operate only intermittently.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a simplified diagram of an example embodiment of an asset-monitoring apparatus according to an embodiment of the present invention, comprising a sensor system powered by scavenging energy via a current transformer that is placed around the power line of the asset being monitored, in communication with a monitoring system;

FIG. 2 is a simplified diagram of the elements of an embodiment of a sensor package according to one aspect of the present invention;

FIG. 3 is a simplified diagram of an example implementation of the present invention when the asset is an AC-powered motor;

FIG. 4 is a diagram of an embodiment of a power conditioning circuit according to another aspect of the present invention;

FIG. 5 is a simplified diagram of an alternative embodiment of a monitoring system useful with one aspect of the present invention; and

FIG. 6 is a simplified diagram of another alternative embodiment of a monitoring system useful with one aspect of the present invention.

### DETAILED DESCRIPTION

In the present invention, an electronic device is powered by scavenging electronic energy via a transformer placed around a power line or power circuit. In a preferred embodiment, a power supply according to the present invention comprises a current transformer that is placed around the power line and is connected to a power conditioning system that provides a conditioned power source for the electronic device. Power for the electronic device and the associated conditioning hardware is generated by scavenging power from the power being supplied to some other machine or area.

As used herein, the following terms expressly include, but are not to be limited to:

“Asset” means any device, circuit, system, or mechanism powered by electric current and, in particular, one that is being, or is desired to be, monitored using a sensor or other electronic device;
“Asset-monitoring apparatus” means one or more devices, circuits, systems, or mechanisms that make up a system for gathering information about the operation of one or more assets;
“Current transformer” means an instrument transformer-intended to have its primary winding around a circuit carrying the current to be measured or controlled, with the current being measured across the secondary winding;
“Electronic device” means any device powered by electricity including, but not limited to, a device requiring a standard 110-volt power source;
“Energy storage device” means any device capable of receiving and storing voltage or current for future use;
“Monitoring electronics” means circuitry and devices for supporting and operating one or more monitoring sensors;
“Monitoring system” means an information gathering system for receiving, and optionally processing, data from one or more sensors;
“Power circuit” means the wires that carry current to electric motors and other devices that use electric power;
“Power conditioning system, unit, device, or circuit” means a device, circuit, or system that receives the potentially variable incoming power from a transformer and converts it to a conditioned supply that electronic devices can use;
“Power line” means two or more electric wires carrying power from one location to another;
“Sensor” means a device that senses either the absolute value or a change in a physical quantity such as, but not limited to, temperature, pressure, vibration, flow rate, or pH, or the intensity of light, sound, or radio waves, and converts that change into a useful input signal for an information gathering system; and
“Transformer” means an electrical component consisting of two or more multiturn coils of wire placed in close proximity to cause the magnetic field of one to link the other, used to transfer electric energy from one or more alternating current circuits to one or more other circuits by magnetic induction.

In a preferred embodiment, a system comprises a sensor package in communication with a monitoring system and a device that generates power for the sensor package. Power for the sensor, any associated hardware, and a wireless communications device is generated by scavenging power from the power being supplied to the machine that is being sensed. The power-generating device includes a current transformer that is placed close to the power line powering the asset being monitored by the sensor and is connected to a power conditioning system that provides a conditioned power source for the sensor package. The transformer scavenges power from the power line. The power coming from the current transformer is anticipated to be variable in nature, so the power conditioning unit converts it to a conditioned supply that the electronics can use.

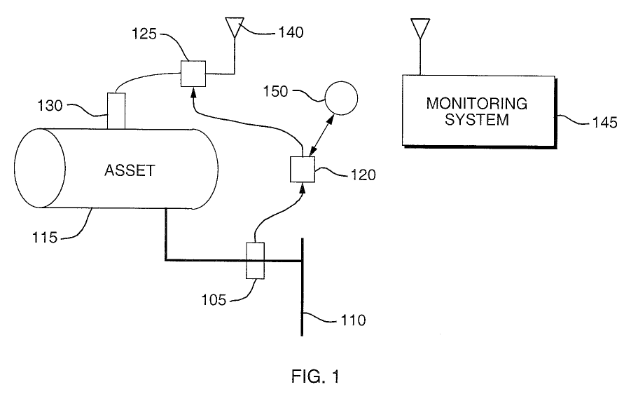

FIG. 1 is a simplified diagram of an example embodiment of an asset-monitoring apparatus according to an embodiment of the present invention, comprising a sensor system powered by scavenging energy via a current transformer that is attached to the power line of the asset being monitored, in communication with a monitoring system. In FIG. 1, transformer 105 is placed close to power line 110, which is supplying power to asset 115. Current induced in transformer 105 enters power conditioning unit 120, where it is converted to a power supply that the electronics can use. Sensor electronics 125, monitoring sensor 130, and wireless transmitter or transceiver 140 all may receive power from power conditioning unit 120, either directly or through one of the other devices. Measurements from sensor 130 are sent by monitoring electronics 125 to wireless transmitter or transceiver 140, which in turn transmits them to monitoring system 145.

In a preferred embodiment, the apparatus also includes energy storage device 150, which is capable of powering monitoring electronics 125 if insufficient power is being produced by the primary power source via power conditioning unit 120. Since the abrupt loss of power or variations in the current supplied to monitoring electronics 125 might also adversely affect the operation of monitoring sensor 130, there may arise a need to provide for continuity of power provision across any potentially intermittent nature of the primary power source. Energy storage device 150 may be any suitable device known in the art, including, but not limited to, one or more rechargeable batteries and/or capacitors. While energy storage device 150 is depicted in FIG. 1 as being connected only to power conditioning unit 120, in order to receive excess power from unit 120 and/or deliver power to unit 120 when required, it will be clear to one of ordinary skill in the art that energy storage device 150 may also be installed in the system of the present invention in other configurations, dependent upon the particular implementation and intended function of device 150, including, but not limited to, being connected in parallel with power conditioning unit 120, being connected in series on either side of power conditioning unit 120, or being connected directly to monitoring electronics 125. It will further be clear to one of ordinary skill in the art that energy storage device 150 may comprise any number of batteries, capacitors, or other suitable devices, in any suitable configuration for the intended purpose of the device in the particular implementation of the invention.

One general purpose of optional energy storage device 150 is to provide continuity of operation for the monitoring electronics. Therefore, a preferred embodiment is a battery or storage capacitor whose charging circuit is fed, either constantly or intermittently, by the output of the power conditioning unit, in order to maintain a full charge. Among other advantages, this permits the monitoring system to be able to communicate the state of the monitored asset during intermittent power losses, as well as to be able to capture startup measurements when power from the power line to the asset is either being restored or becoming stable. It also permits the system to have “graceful” shutdowns when the primary power disappears. Particularly in the case where the primary power line is fed from a different asset from the one that is being monitored, it is clearly undesirable for the loss of power source to prevent the monitor from being operational. The energy storage device may additionally, or alternatively, provide required power to operate the power conditioning unit itself. In an alternative embodiment, the energy storage device may be replaced or augmented with a device that may wirelessly receive power via RF transmission.

In an alternate implementation, the energy storage device may be used as the primary source of power for the monitoring electronics, with the power conditioning unit being used to recharge, or at least partially recharge, the energy storage device and thereby prolong the time periods between required servicing/recharging of the energy storage device. This type of implementation would be particularly suitable in situations where the primary power line source is likely to be intermittent, the power demands of the monitoring electronics are particularly high, and/or the output of the power conditioning unit is not expected to be sufficient to power the monitoring electronics when needed. In some embodiments, especially where the power conditioning unit is powered from the same intermittent primary power line source, the energy storage device may also be used to power the power conditioning unit when the primary power source is unavailable. As will be clear to one of skill in the art, in such an implementation the energy storage device could be connected directly to the sensor electronics, with the power conditioning unit being connected to the charging circuitry of the storage device.

In one embodiment, the monitoring electronics can also monitor the state of the energy storage device, providing for the option of having the monitoring electronics enter a low power state until the storage device is sufficiently charged by scavenged current received from the power conditioning unit. In this embodiment, the monitoring electronics may further, or alternatively, be able to match the frequency of monitoring to the frequency that can be supported by the scavenged power/current. As will be understood by one of ordinary skill in the art, this can be easily implemented by a monitoring system that also monitors available power and adjusts its operation accordingly.

In a preferred embodiment, the transformer is a standard current transformer. Suitable devices include, but are not limited to, CR Magnetics CR3110 or CR7-RL-XXX devices. In particular, the CR3110 transformer has a split core, which permits it to be field mounted on an existing power line without the need to disconnect the power line. It will be understood by one of skill in the art, however, that while it may in some circumstances be desirable to use a split core or other clampable transformer for the purpose of ease of installation, this is not an absolute requirement, and designs using other types of transformers are considered to be within the scope of the invention. It will be clear to one of ordinary skill in the art that the invention is suitable for use with any type of power line source, with the appropriate transformer and power conditioning unit being selected according to the power line source and the amount of current/voltage required to operate the monitoring and/or other electronics.

In a typical implementation, the current transformer primary winding is clamped onto an existing power line. As long no current is being drawn from the power line (i.e., no load is connected), the transformer primary winding will not have any current. As current is drawn from the power line by a load, an AC current is produced in the transformer primary winding. This AC current is then coupled onto the transformer secondary winding. The amount of AC current seen on the secondary winding depends on the design of the transformer. If a load resistor is then placed in parallel with the secondary winding, an AC voltage will be produced at a current determined by, but not limited to: the resistance value of the load resistor, the amount of current drawn on the power line (i.e., the load placed on the line), the between the number of transformer primary windings and the number of transformer secondary windings, and the DC resistance of the transformer windings. The AC voltage made available across this load resistor is then conditioned by the power conditioning unit in order to produce a DC voltage at some current in order to power the monitoring electronics and/or charge the energy storage unit. In one embodiment, the AC voltage is rectified by means of any of the many methods known in the art and then is filtered or smoothed to produce the DC voltage.

In one preferred embodiment, the asset is typically a piece of industrial machinery (pump, compressor, etc.) with an associated electric motor. The motor and asset may be connected by a belt or shaft. The sensor monitors a physical attribute (vibration, temperature, pressure, etc.) from a location on the asset. The sensor electronics may provide power to the sensor, receive signals from the sensor, convert signals to digital information, and perform other functions. The transmitter or transceiver transmits the digital information directly or indirectly via a network to a monitoring system. In addition to sending data from the sensor, the transmitter or transceiver can transmit status information about itself, the sensor, and/or the monitoring electronics. If a transceiver is used, it can receive data and/or commands from a monitoring system intended for itself, for the sensor, and/or for the sensor electronics. The monitoring system is typically a computing device, which may be running special code or may have a connection directly to the sensor and/or monitoring electronics by running a Web browser. In a wireless application, it may have a wireless transmitter or transceiver directly attached to it, or it may be connected via a wired network to a point where the network becomes wireless.

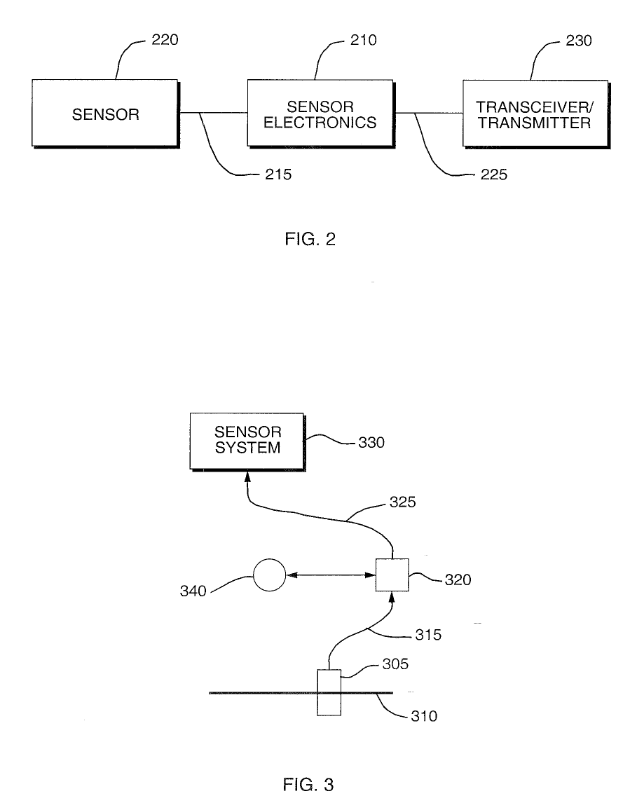

FIG. 2 is a simplified diagram of the three main elements of an embodiment of a sensor package according to an aspect of the present invention: at least one sensor, associated monitoring electronics, and a wireless transceiver/transmitter. In FIG. 2, sensor 220 and sensor electronics 210 are connected 215 via any of the many means known in the art. Sensor electronics 210 are further connected 225 to wireless transmitter or transceiver 230, also via any of the many means known in the art. The three elements may be supplied as three separate packages, may be supplied as a single package, or may be combined into any number of packages suitable for a specific implementation. Transceiver/transmitter 230 may be wired or wireless, as is desired for the particular implementation. In a typical implementation, sensor 220 is, but is not limited to, an accelerometer. A suitable device includes, but is not limited to, a CTC AC-102. Typical sensor electronics include, but are not limited to, the Azima I-400 and Azima R-100, by Azima, Inc., Woburn, Ma, USA. Suitable wireless transmitters or transceivers include, but are not limited to, WiFi cards embedded in sensor electronics 210 and the Tranzeo 6015.

FIG. 3 is a simplified diagram depicting an example embodiment of the present invention when the asset is an AC-powered motor. In FIG. 3, current transformer 305 is placed around input AC line 310, which is powering the motor. Low voltage AC 315 generated at transformer 305 is delivered to power conditioning unit 320. Conditioned voltage 325 is then used to power sensor system 330. Optional energy storage device 340 may also be present, as either the primary or backup source of power for sensor system 330.

The power conditioning unit receives the current scavenged by the transformer from the primary power source, processes it, and uses it to provide a DC voltage that powers the monitoring electronics. Alternatively, or in addition, the output of the power conditioning unit can be fed to the charging circuit of an energy storage device. In one implementation, wherein the monitoring sensor operates intermittently, the power conditioning unit provides power to the sensor electronics when they are required to operate and to the energy storage device during the remaining time, in order to provide a backup power source in the event that the primary power source is not operating or the power conditioning unit is otherwise unable to provide sufficient power to the sensor electronics. As will be clear to one of ordinary skill in the art, the design of the power conditioning unit will be dependent on the transformer type and output, as well as the power requirements of the monitoring electronics and the power conditioning unit itself. In a preferred embodiment, the power conditioning unit is a voltage regulator with a full wave rectifier to produce DC power at the proper voltage. Many suitable devices are known in the art of the invention, including, but not limited to, the Precision Rectifier Circuit for CT Signal Conditioning described in Application Sheet ANCRCT-4 by CR Magnetics, St. Louis, Mo., USA, which sheet is herein incorporated by reference.

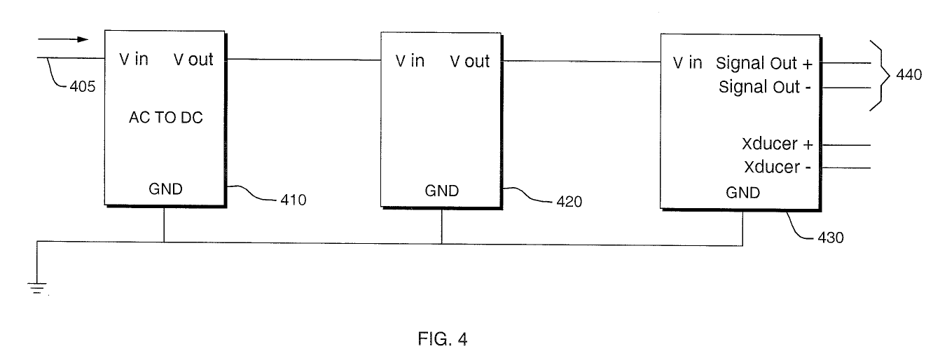

FIG. 4 is a diagram of an embodiment of a power conditioning unit according to one aspect of the present invention. In FIG. 4, current 405 from the transformer is delivered to AC-Current to DC-Voltage converter and regulator 410. The output from AC-Current to DC-Voltage converter and regulator 410 is provided to battery and charger 420, and the output of battery and charger 420 is provided to accelerometer power supply 430. The power conditioning unit thus provides conditioned power output 440 suitable for powering an associated electronic device. While a specific implementation is shown, it is clear to one of ordinary skill in the art that there are many other possible implementations that would all be suitable for use in the present invention. While an accelerometer power supply is shown, other types known in the art would also be suitable, including, but not limited to, pressure transducer, RTD conditioner, thermocouple power supply, current transmitter, flow transmitter, and PH transmitter.

In alternative embodiments, the power supplied to the electronic device can be increased by using multiple transformers in order to scavenge sufficient power. In some such embodiments, multiple transformers are connected in parallel to the power conditioning unit in any of the many suitable manners known in the art of the present invention and/or multiple power conditioning units are employed, also in any of the many suitable manners known in the art. These embodiments are useful when a single transformer does not supply sufficient voltage to the conditioning circuit to power the electronic device or devices. Alternatively, if more output is needed, the design of a single current transformer can be altered by adjusting the turn ratio to get more or less power, which may in some circumstances be preferable to installing and wiring more current transformers into the system.

It will be clear to one of ordinary skill in the art of the invention that the power supply of the present invention may also be used for powering multiple devices, either in parallel, if sufficient current is available, or alternately, if one or more of the powered devices are intended to operate only intermittently. In one such example, a sensor that takes temperature readings every 30 seconds may be powered alternately with a transceiver that relays those measurements to the monitoring system. In another example, multiple sensors, each monitoring a different parameter (e.g. vibration and temperature) may be simultaneously powered by the power supply of the present invention. Alternatively, the device may be used to charge a battery or other energy storage device, and then the battery can be used to handle surges of power when required by multiple devices.

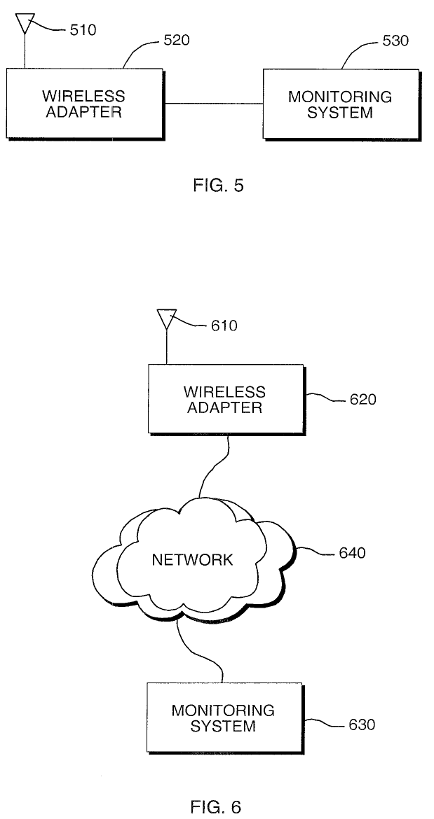

FIGS. 5 and 6 are simplified diagrams depicting example embodiments of some of the many other acceptable variants of a monitoring system useful with an asset-monitoring apparatus according to one aspect of the present invention. In FIG. 5, receiver or transceiver 510, connected to wireless adaptor 520, receives commands from and/or sends data to monitoring system 530. In one example embodiment, presented for illustrative purposes only and not to be construed as limiting, receiver or transceiver 510 is an antenna, wireless adaptor 520 is a Tranzeo 6015, and monitoring system 530 is an Azima I-1600. In FIG. 6, receiver or transceiver 610, connected to wireless adaptor 620, receives commands from and/or sends data to monitoring system 630 via network 640. Network 640 is typically an internet connection, but may also be an intranet, VPN, cell network, or any of the many other suitable networking devices or methodologies known in the art.

In one specific exemplary implementation, a large motor driven pump at a power production facility needs to have its health checked at least once per day. There is high voltage power (6900 volts) being used to power the motor, but no low voltage power available to power the monitoring device. In order to power the monitoring device, it would be necessary to install a low voltage power line to the pump, costing thousands of dollars and taking several months for design and approval. The present invention, using a split core current transformer, can be installed in a matter of minutes. It then powers a sensor hub that collects dynamic vibration data from the pump and its drive motor. The data from that hub is then transmitted to a remote site where the health of the machine is monitored. In this implementation, the transformer is a CR-RL--62, the power conditioning apparatus is custom-built according to the design of FIG. 4, the sensor is a CTC AC-102, the sensor electronics are provided by an Azima I-400, and the wireless adaptor is included in the Azima I-400.

In particular, the present invention is not limited to use in a wireless asset-monitoring apparatus, but rather may also be advantageously employed in many other types of situations and devices such as, but not limited to, sensors without access to a power source where data is periodically collected directly at the sensor location, sensors utilized in any situation where it is not feasible or desirable to provide a separates power source for the sensor or to power the sensor from the available power supply, and for powering devices other than sensors that are, or may be, associated with powered devices. The present invention may also be employed for powering completely unrelated electronic devices, so long as the power line for another device is suitably accessible. It is further envisioned that the present invention may be particularly useful when there is a need to power one or more electronic devices in a situation where a high voltage supply is present, but a power distribution unit is not available and/or the use of one is not feasible. Examples include, but are not limited to, remote conveyor drives, which always have high voltage power but often do not have any low voltage power available, and nuclear power plants, which always have high voltage power to run the machines but low voltage power is either not available or the design modification required to tap into it is so costly as to be prohibitive.

The present invention therefore provides a means for powering electronic devices utilizing an available power source when no direct connection to the power system is available and/or feasible. The present invention also provides a power source for sensors and other electronic devices that is consistently available, simple and inexpensive to implement and operate, does not require periodic replacement or servicing, and can be installed, reconfigured, of removed at any time, particularly without the need to make any direct alterations to the originating power source. While a preferred embodiment is disclosed many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A power supply for an electronic device, comprising:
at least one transformer, the transformer intended for placement around a power line so that current is induced in the transformer by electronic energy in the power line;
at least one power conditioning unit connected to the transformer, the power conditioning unit containing electronics for converting the induced current into a voltage supply that is useable by the electronic device; and
at least one voltage output connected to the power conditioning unit and connectable to the electronic device in a manner suitable for providing power to the device.

2. The power supply of claim 1, further comprising at least one energy storage device, the energy storage device being connected to the power conditioning unit and rechargeable thereby, wherein the energy storage device provides power to at least one of the voltage output or power conditioning unit when power is not being supplied to the electronic device from the transformer via the power conditioning unit.

3. An electronic device having a power supply, comprising:
at least one transformer, the transformer intended for placement within an effective distance from an active power line so that current is induced in the transformer by electronic energy in the power line;
at least one power conditioning unit connected to the transformer, the power conditioning unit containing electronics for converting the induced current into a voltage supply that is useable by the electronic device; and
device electronics connected to the power conditioning unit for receiving the voltage and causing the device to operate.

4. The electronic device of claim 3, wherein the device comprises at least one sensor.

5. The electronic device of claim 4, further comprising a wireless transmitter for receiving data obtained by the sensor and transmitting it to a receiver.

6. The electronic device of claim 3, further comprising at least one energy storage device, the energy storage device being connected to the power conditioning unit and rechargeable thereby, wherein the energy storage device provides power to at least one of the device electronics or power conditioning unit when power is not being supplied to the electronic device from the transformer via the power conditioning unit.

7. An asset-monitoring system, comprising:
at least one sensor having associated monitoring electronics;
at least one current transformer, the transformer intended for placement within an effective distance from a power line supplying power to the asset in order that that current is induced in the transformer by electronic energy in the power line;
at least one power conditioning unit connected to the transformer and the sensor electronics, the power conditioning unit containing electronics for converting the induced current into a voltage supply that is useable by the monitoring electronics; and
a monitoring system for receiving data obtained by the sensor.

8. The asset-monitoring system of claim 7, further comprising at least one energy storage device, the energy storage device being connected to the power conditioning unit and rechargeable thereby, wherein the energy storage device provides power to at least one of the monitoring electronics or power conditioning unit when power is not being supplied from the transformer.

9. The asset monitoring system of claim 7, further comprising:
a wireless transmitter connected to the sensor electronics for receiving and transmitting data obtained by the sensor; and
a wireless receiver for receiving data from the wireless transmitter and transmitting it to the monitoring system.

10. The asset-monitoring system of claim 9, further comprising at least one energy storage device, the energy storage device being connected to the power conditioning unit and rechargeable thereby, wherein the energy storage device provides power to at least one of the monitoring electronics or power conditioning unit when power is not being supplied from the transformer.

11. The asset-monitoring system of claim 7, further comprising at least one wireless power supply, the wireless power supply being connected to the power conditioning unit, wherein the wireless power supply provides power to at least one of the monitoring electronics or power conditioning unit when power is not being supplied from the transformer.

12. The asset-monitoring system of claim 8, the monitoring electronics further comprising an energy level monitor that monitors the level of energy available from at least one of the energy storage device or power conditioning unit, the monitoring electronics timing operation of the sensor according to the availability of power from the energy storage device and remaining in a low power mode when the sensor is not in operation.

13. A method for powering an electronic device, comprising the steps of:
inducing current in at least one transformer by placing the transformer within an effective distance from an active power line so that current is induced in the transformer by electronic energy in the power line;
converting the induced current into a voltage supply that is useable by the electronic device; and
powering the electronic device with the voltage supply.

14. The method of claim 13, further comprising the steps of:
charging an energy storage device with the voltage supply; and
powering the electronic device from the energy storage device when insufficient power is being received from the voltage supply to power the electronic device.

15. A method for monitoring an asset, comprising:
inducing current in at least one transformer by placing the transformer within an effective distance from the power line supplying the asset so that current is induced in the transformer by electronic energy in the power line;
converting the induced current into a voltage supply that is useable by an electronic device;
powering at least one sensor with the voltage supply;
sensing the asset with the sensor; and
providing data obtained by the sensor to a monitoring system.

16. The method of claim 15, the step of providing data comprising:
transmitting the data with a wireless transmitter;
receiving the data with a wireless receiver; and
providing the received data to the monitoring system.

17. The method of claim 16, further comprising the steps of:
charging an energy storage device with the voltage supply; and
powering the sensor from the energy storage device when insufficient power is being received from the voltage supply to power the sensor.

18. The method of claim 16, further comprising the steps of:
receiving power from at least one wireless power supply; and
powering the sensor from the wireless power supply when insufficient power is being received from the voltage supply to power the sensor.

19. The method of claim 13, further comprising the steps of:
monitoring the level of energy available from the voltage supply;
operating the sensor on a schedule according to the availability of power from the voltage supply; and
operating the sensor in a low or no power mode when the sensor is not required to be in operation.
